(19) United States
(12) Patent Application Publication
(10) Pub. No.: US 2010/0311888 A1
(43) Pub. Date: Dec. 9, 2010

(54) ACRYLIC THICKENER COMPRISING A BRANCHED HYDROPHOBIC-CHAIN FOR A PAPER COATING SLIP WITH IMPROVED WATER RETENTION

(75) Inventors: Francois Dupont, Lyon (FR); Jean-Marc Suau, Lucenay (FR); Jacques Mongoin, Quincieux (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: COATEX S.A.S., GENAY (FR)

(21) Appl. No.: 12/744,688

(22) PCT Filed: Dec. 2, 2008
(86) PCT No.: PCT/IB08/03368

§ 371 Date: May 26, 2010

(30) Foreign Application Priority Data
Dec. 17, 2007 (FR) 0708761

(51) Int. Cl. C08K 3/26

(52) U.S. Cl. 524/425

(57) ABSTRACT

The invention consists of the use, within a method for manufacturing a paper coating, as a thickening agent of said coating, of a water-soluble polymer characterized in that it is made up of at least one ethylenically-unsaturated anionic monomer, of at least one ethylenically-unsaturated oxyalkylated monomer terminated by a branched hydrophobic alkyl, alkylaryl, arylalkyl, or aryl chain having 14 to 24 carbon atoms, and possessing 2 branches having at least 6 carbon atoms. The water retention of said coating is thereby improved, which contributes to a better printability of the paper coated by said coating.

In connection with the manufacture of a coated sheet of paper, a first stage consists in transforming the paper pulp, by means of the paper machine, into a sheet of paper, which is not yet coated. The paper pulp essentially contains natural or synthetic fibers, water, and one or more mineral materials such as calcium carbonate, together with various other additives such as so-called “gluing” agents. It is then said that a mineral filler (such as calcium carbonate) is used as a “mass filler”.

The second step resides in the coating of the previously obtained sheet. This operation consists of depositing onto the surface of the paper substrate an aqueous composition known as “paper coating” which particularly contains water, one or more mineral materials such as calcium carbonate, one or more binders, and various additives. When manufacturing a paper coating, the use of a mineral material (such as calcium carbonate) is spoken of in terms of “coating pigments”.

After depositing onto the substrate, the paper coating possesses a natural tendency to transfer into the substrate all or some of the water and water-soluble or suspended substances that it contains. It is then sought to slow this migration into the substrate paper, in view of maintaining an even distribution of the water-soluble or suspended substances within the thickness of the paper coating thereby deposited, which ultimately improves the surface condition and printability of the paper.

In order to slow the penetration of the paper coating into the sheet, there are 2 ways depending on whether you work with the paper coating or the paper sheet.

The first consists of altering the absorption properties of the substrate paper by reducing its porosity or by increasing its degree of hydrophobicity. To that end, one may use when manufacturing the sheet particular agents known as “coating penetration inhibitors” like hydrophilic resins (JP 06-219038), “gluing” agents of a hydrophobic nature such as resins with aluminum sulfates (WO 96/23105), or “treatment” agents which make the calcium carbonate surface used in the sheet as a mass filler hydrophobic, these agents being, for example, fatty acids C16-C18 (U.S. Pat. No. 5,514,212), or hydrophobic acrylate-based, acrylonite-based and styrene-based polymers (WO 01/86067).

One may also note the French patent application filed as number 06 08927 but not yet published as of the filing of the present Application, and which describes the use as a mass filler of an aqueous suspension of calcium carbonate, dispersed and/or ground with the polymers which are the object of the present invention. This document therefore does not concern the formulation of paper coatings, any more than it discloses the surprising effect of the polymers of the present invention, as thickening agents for said coating. However, this document does disclose the surprising manner in which said polymers, in association with a calcium carbonate used as mass filler, make it possible to slow the penetration of the coating into a sheet of paper by increasing the degree of hydrophobicity of said sheet.

In contrast, the present invention falls within the category of solutions which seek to slow the penetration of the coating by increasing its viscosity. When the viscosity of the coating is increased in this matter, its penetration into the sheet, meaning the migration of water and water-soluble substances within the sheet of paper, is slowed: this is referred to as improved “water retention”.

To that end, it is well-known how to use as water-retaining/thickening agents for paper coatings, starch, polyvinyl alcohol (PVOH), carboxymethylcellulose-based polymers (CMCs), latexes and emulsions of highly carboxylated polymers, polycarboxylates such as polyacrylates, or finally, the particular class of alkali-inflatable polymers. These products are particularly described in EP document 0,509,878, as the subject of the invention with regard to alkali-inflating polymers, and as the state of the art for the other polymers mentioned above.

From a practical viewpoint, the person skilled in the art primarily implements acrylic thickeners (such as Rheocoat™ 35 sold by COATEX™ or Sterocoll™ sold by BASF™) and cellulosic thickeners (such as the product Finnfix™ sold by BASF™). However, cellulosic thickeners exhibit the drawback of coming in the form of powders, which lead to problems of pollution in facilities (their powdery nature), handling (the difficulty of carrying a powder through a pipe), and which must generally be placed in an aqueous solution, which represents an additional step for the formulator. The person skilled in the art therefore prefers to implement acrylic polymers, while remaining sensitive to increasingly restrictive environmental legislation, as indicated in documents WO 2006/081501 and EP 0,839,956: it is sought to reduce the quantity of these acrylic polymers in coating formulations.

This last restriction obviously applies to all acrylic polymers found within the coating slip:
to the acrylic thickeners mentioned above, which are added to the coating when they are manufactured,
to the acrylic dispersing and grinding aid agents which were implemented during a step of dispersing, grinding, adding or concentrating a calcium carbonate in an aqueous medium, potentially followed by a step of drying, with the suspension or dispersion of the resulting dry material then taking place within the manufacturing of the paper coating.

The technical problem which is the subject of the present Application may therefore be likened to:
seeking out a solution for slowing the penetration of a paper coating within a sheet of paper coated using said coating,
by implementing acrylic polymers preferred over cellulosic thickeners in powdered form,
with the need to reduce the total quantity of acrylic polymers (thickening agents, dispersing agents, and grinding aid agents) implemented within the overall coating manufacturing method, comprising both the step of manufacturing an aqueous suspension of mineral materials, then the step of manufacturing the coating from the suspension or dispersion of the previously obtained dry mineral material.

This slowing of the migration of the coating within the sheet of paper will translate into an increase in the viscosity of said coating and better water retention. It will ultimately lead to an improvement of the printability properties of the coated sheet of paper.

To that end, the Applicant has developed the use, within a method for manufacturing a paper coating containing at least one mineral material, as an agent for thickening said coating, a water-soluble polymer characterized in that it is made up of:
a) at least one ethylenically-unsaturated anionic monomer,
b) and at least one ethylenically-unsaturated oxyalkylated monomer terminated by a branched hydrophobic alkyl, alkylaryl, arylalkyl, or aryl chain, whether saturated or not, having 14 to 21 carbon atoms and possessing 2 branches having at least 6 carbon atoms.

There are 3 methods for introducing this polymer into the coating: all 3 lead to a reduction in the overall quantity of acrylic polymers implemented (dispersing agent, grinding aid agent, and thickening agent), compared to the same coating not containing the inventive polymer and, with equivalent or even improved performance in terms of thickening and retaining water.

In a first variant, this polymer is implemented during a step of dispersing, grinding, adding, or concentrating a mineral material in an aqueous medium, potentially followed by a step of drying. The resulting dispersion or aqueous suspension then is used in manufacturing a paper coating.

In a second variant, this polymer is implemented as a direct additive during the manufacturing of the paper coating.

In a third variant, this polymer is implemented both during a step of dispersing, grinding, adding, or concentrating a mineral material in an aqueous medium, and as a direct additive during the manufacturing of the paper coating.

The resulting paper coatings, compared to the paper coatings of the prior art which do not contain said polymer:
then exhibit a greater thickening effect (Brookfield™ viscosities of 10 and 100 revolutions per minute and 25° C.), and greater water retention, while containing a quantity of acrylic polymers by weight (dispersing, grinding, and thickening agents) equal to that contained within the coatings of the prior art,
or exhibiting a thickening effect (Brookfield viscosities™ of 10 and 100 revolutions per minute and 25° C.) and identical water retention, while containing a quantity of acrylic polymers by weight (dispersing, grinding, and thickening agents) less than that contained within the coatings of the prior art.

Furthermore, besides granting better properties to the final coating, said polymer also makes it possible to create aqueous dispersions and suspensions of mineral materials (whenever it is added during a step of dispersing, grinding, adding, or concentrating in aqueous media) which are entirely acceptable for the person skilled in the art, particularly meaning that they are pumpable and workable. Concretely, aqueous dispersions and suspensions with a Brookfield™ viscosity of 100 revolutions per minute and 25° C. at less than 1,000 mPa·s.

In order to explain such results, though without considering herself bound to any theory whatsoever, the Applicant believes that the inventive polymer may develop not only properties of stabilizing, dispersing, and grinding mineral materials in water, but also thickening effects in the presence of latex, all via associative interactions between these hydrophobic R′ groups and the latexes contained within the paper coating. Such interactions would be the cause of a thickening effect caused by the inventive polymer.

This particular results is all the more surprising given that polymers of acrylic acid with the monomer whose formula is (I) and a lateral hydrophobic R′ chain are already known, the person skilled in the art having broadly varied the length of the R′ chain, though without ever having obtained a thickening effect. Indeed, all of these polymers are described as dispersing agents of mineral loads: thus, this dispersing mechanism is connected to a phenomenon of the fluidification of the medium, and not to the thickening effect sought here by the person skilled in the art.

The document EP 1,294,476 thereby describes polymers with an anionic monomer such as acrylic acid and a monomer whose formula is (I) wherein R′ refers to a barely hydrophobic radical having 1 to 5 carbon atoms; these polymers particularly behave as excellent agents for dispersing the calcium carbonate.

The document EP 1,565,504 describes copolymers of acrylic acid and a monomer whose formula is (I), wherein R′ very broadly possesses 1 to 40 carbon atoms; these polymers improve the optical whitening of the paper coatings, and may be added into the coatings through a step of dispersing the calcium carbonate. The documents EP 1,569,970 and EP 1,572,764 describe the same chemical structures, but respectively implemented as grinding aid agents and as agents improving the brightness of a coated sheet of paper.

The document WO 2007/069037 reveals that polymers of acrylic acid and monomer whose formula is (I) wherein R′ possesses 1 to 40 carbon atoms but is preferentially the methyl group, making it possible to constantly improve the retention of a paper coating in water, while keeping its viscosity at a relatively low level.

Finally, the documents EP 0 892 020 and EP 0,892,111 instructed that the particular choice for R′ of a hydrophobic radical having at least 22 carbon atoms makes it possible, for polymers of acrylic acid and a monomer whose formula is (I), to effectively disperse or grind both hydrophilic (calcium carbonate) or hydrophobic (talc) mineral materials in water.

Consequently, the prior art had already foreseen numerous possibilities for the R′ grouping: each of them clearly led to a dispersing, grinding-aiding, brightness-improving, or optical whitening-improving polymer, and not a paper coating thickener. One of the applicant's merits is having initially believed that choosing a different R′ would lead to a thickening effect.

Another one of her merits is having been able to identify such R′ groups, through the very particular choice of a branched hydrophobic chain having 14 to 21 carbon atoms and possessing 2 branches having at least 6 carbon atoms. Nothing disclosed or suggested such a choice; nothing presaged that such a choice could have led to as remarkable a technical effect: reducing the quantity of acrylic polymers in the paper coating, for a thickening performance equivalent to the prior art.

Thus, the invention consists of the use, within a method for manufacturing a paper coating containing at least one mineral material, as a thickening agent of said coating, of a water-soluble polymer characterized in that it is made up of:
a) at least one ethylenically-unsaturated anionic monomer,
b) and at least one ethylenically-unsaturated oxyalkylated monomer terminated by a branched hydrophobic alkyl, alkylaryl, arylalkyl, or aryl chain, whether saturated or not, having 14 to 21, and preferentially 15 to 20 carbon atoms and possessing 2 branches having at least 6 carbon atoms.

This use of a water-soluble polymer, within a method for manufacturing a paper coating containing at least one mineral material, is further characterized in that said polymer contains, expressed as a percentage by the weight of each of the monomers (the total of these percentages being equal to 100%):
a) 5% to 95%, preferentially 50% to 95%, and very preferentially 70% to 95%, of at least one ethylenically-unsaturated anionic monomer,
b) 5% to 95%, preferentially 5% to 50%, and very preferentially 5% to 30% of at least one ethylenically-unsaturated oxyalkylated monomer terminated by a branched hydrophobic alkyl, alkylaryl, arylalkyl, or aryl chain, whether saturated or not, having 14 to 21, and preferentially 15 to 20 carbon atoms, and possessing 2 branches having at least 6 carbon atoms.

This use of a water-soluble polymer, within a method for manufacturing a paper coating containing at least one mineral material, is further characterized in that the monomer a) is chosen from among acrylic acid, methacrylic acid, and mixtures thereof.

This use of a water-soluble polymer, within a method for manufacturing a paper coating containing at least one mineral material, is further characterized in that the monomer b) is a monomer whose formula is (I):

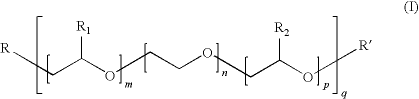

where:
m, n, p and q are whole numbers and m, n, p are less than 150, q is greater than 0, and at least one whole numbers among m, n and p is nonzero;
R is a radical containing a polymerizable unsaturated function, preferentially belonging to the group of vinylics as well as the group of acrylic, methacrylic, and maleic esters, and to the group of unsaturated urethanes such as acrylurethane, methacrylurethane, α-α′ dimethyl-isopropenyl-benzylurethane, allylurethane, as well as to the group of allylic or vinylic ethers, whether substituted or not, or to the group of ethylenically unsaturated amides or imides,
R₁ and R₂ are identical or different, and represent hydrogen atoms or alkyl groups,
R′ represents a branched hydrophobic alkyl, alkylaryl, arylalkyl, or aryl chain, whether saturated or not, having 14 to 21, preferentially 15 to 20 carbon atoms, and possessing 2 branches having at least 6 carbon atoms, and in that R′ is extremely preferentially chosen from among 2-hexyl 1-decanyl, le 2-octyl 1-dodecanyl and mixtures thereof.

This use of a water-soluble polymer, within a method for manufacturing a paper coating containing at least one mineral material, is further characterized in that said water-soluble polymer is partially or fully neutralized by one or more neutralization agents having a monovalent or polyvalent function, preferentially chosen from among sodium hydroxide, potassium hydroxide, and mixtures thereof.

During this use within a method for manufacturing a paper coating containing at least one mineral material, said water-soluble polymer may be implemented:
either by direct introduction into the paper coating,
or during a step of dispersing, grinding, or concentrating said mineral material in an aqueous medium, potentially followed by a step of drying.

This use of a water-soluble polymer, within a method for manufacturing a paper coating containing at least one mineral material, is further characterized in that said mineral material is chosen from among natural or precipitated calcium carbonate, kaolin, talc, and mixtures thereof, and in that it is preferentially natural or precipitated calcium carbonate or a kaolin or mixtures thereof, and in that it is very preferentially a mixture of natural calcium carbonate and kaolin.

This use of a water-soluble polymer, within a method for manufacturing a paper coating containing at least one mineral material, is finally characterized in that the percentage by dry weight in relation to the dry weight of mineral material, is between 0.1% and 2%, and preferentially between 0.2% and 0.8%.

### EXAMPLES

### Example 1

This test illustrates the implementation of the inventive polymer in an aqueous suspension of calcium carbonate, during a step of adding or grinding. These suspensions are then used in the manufacturing of paper coatings which exhibit improved water retention and thickening, compared to a paper coating of the prior art derived from an aqueous suspension of calcium carbonate without the inventive polymer, both coatings ultimately exhibiting the same quantity of acrylic polymer (a dispersing agent or grinding aid agent added into the aqueous suspension+thickening agent added to the coating).

### Test No. 1

This test illustrates the prior art, and implements, by adding into an aqueous suspension produced from calcium carbonate (Norway marble) sold by the company OMYA™ under the name Setacarb™ ME, 0.2% by dry weight in relation to the dry weight of said carbonate, a homopolymer of acrylic acid:
in which 70% by molar weight of the carboxylic sites are neutralized by sodium hydroxide and 30% by molar weight of the carboxylic sites are neutralized by lime.
and with molecular weight equal to 5,500 g/mole (as determined according to the method described in the document WO 2007/069037).

An aqueous suspension is then obtained whose content of calcium carbonate by dry weight is equal to 74.2% of its total weight, and whose Brookfield™ viscosity measured at 100 revolutions per minute is less than 1,000 mPa·s, which makes it completely workable by the user.

### Test #1a

This test illustrates the invention, and implements, by adding into an aqueous suspension produced from calcium carbonate (Norway marble) sold by the company OMYA™ under the name Setacarb™ ME, 0.2% by dry weight in relation to the dry weight of said carbonate, a water-soluble polymer fully neutralized by sodium hydroxide and made up of:
a) 75% acrylic acid by weight,
b) 25% by weight of the monomer whose formula is (I) in which.
   R represents a methacrylate radical,
   R′ represents a branched hydrophobic chain with 16 2-hexyl 1-decanyl carbon atoms,
   m=p=0, q=1, n=25.

An aqueous suspension is then obtained comparable to that obtained for test #1, because its content of calcium carbonate by dry weight is equal to 74.1% of its total weight, and its Brookfield™ viscosity measured at 100 revolutions per minute is less than 1,000 mPa·s, which makes it completely workable by the user.

### Test No. 2

This test illustrates the prior art, and implements, by adding into an aqueous suspension produced from calcium carbonate (Norway marble) sold by the company OMYA™ under the name H90™ ME, 0.2% by dry weight in relation to the dry weight of said carbonate, a homopolymer of acrylic acid:
in which 70% by molar weight of the carboxylic sites are neutralized by sodium hydroxide and 30% by molar weight of the carboxylic sites are neutralized by lime.
and with molecular weight equal to 5,500 g/mole (as determined according to the method described in the document WO 2007/069037).

An aqueous suspension is then obtained whose content of calcium carbonate by dry weight is equal to 77.1% of its total weight, and its Brookfield™ viscosity measured at 100 revolutions per minute is less than 1,500 mPa·s, which makes it difficult to work, and particularly, hard to pump.

### Test #2a

This test illustrates the invention, and implements, by adding into an aqueous suspension produced from calcium carbonate (Norway marble) sold by the company OMYA™ under the name H90™ ME, 0.2% by dry weight in relation to the dry weight of said carbonate, a water-soluble polymer fully neutralized by sodium hydroxide and made up of:
a) 75% acrylic acid by weight,
b) 25% by weight of the monomer whose formula is (I) in which.
   R represents a methacrylate radical,
   R′ represents a branched hydrophobic chain with 16 2-hexyl 1-decanyl carbon atoms,
   m=p=0, q=1, n=25.

An aqueous suspension is then obtained comparable to that obtained for test #2, with regard to its content of calcium carbonate by dry weight, which is equal to 77.4% of its total weight. However, its Brookfield™ viscosity measured at 100 revolutions per minute is less than 1,000 mPa·s, which makes it completely workable by the user, unlike the suspension obtained for test #2.

### Test No. 3

This test illustrates the prior art, and implements, during a step of grinding a calcium carbonate (French calcite) whose diameter is such that 50% of the particles by weight have a diameter greater than that value, is equal to 6.7 μm, 1% by dry weight compared to the dry weight of said carbonate of a homopolymer of acrylic acid:
in which 70% by molar weight of the carboxylic sites are neutralized by sodium hydroxide and 30% by molar weight of the carboxylic sites are neutralized by lime.
and with molecular weight equal to 5,500 g/mole (as determined according to the method described in the document WO 2007/069037).

An aqueous suspension is then obtained whose content of calcium carbonate by dry weight is equal to 71.7% of its total weight, in which 58.9% and 88.5% by weight of the particles are less than 1 μm and 2 μm respectively, and whose Brookfield™ viscosity measured at 100 revolutions per minute is less than 1,000 mPa·s, which makes it completely workable by the user.

### Test #3a

This test illustrates the invention, and implements, during a step of grinding a calcium carbonate (French calcite) whose diameter is such that 50% of the particles by weight have a diameter greater than that value, is equal to 6.7 μm, 1% by dry weight compared to the dry weight of said carbonate of a homopolymer of acrylic acid fully neutralized by sodium hydroxide and made up of:
a) 75% acrylic acid by weight,
b) 25% by weight of the monomer whose formula is (I) in which.
   R represents a methacrylate radical,
   R′ represents a branched hydrophobic chain with 16 2-hexyl 1-decanyl carbon atoms,
   m=p=0, q=1, n=25.

An aqueous suspension is then obtained comparable to that obtained for test #3, because its content of calcium carbonate by dry weight is equal to 71.4% of its total weight, 57.8% and 87.4% of its particles by weight are respectively less than 1 μm and 2 μm; additionally, its Brookfield™ viscosity measured at 100 revolutions per minute is less than 1000 mPa·s, which makes it completely workable by the user.

For tests #3 and #3a, the grinding is carried out according to the method described in the document WO 01/96007.

For each of the tests #1 to #3a, a paper coating is then produced, made up of:
100 parts by dry weight of the aqueous suspension of calcium carbonate to be tested
11 parts by dry weight of the styrene-butadiene latex sold by the company DOW™ CHEMICALS under the name DL 966, for 100 parts by dry weight of calcium carbonate,
0.25 parts by dry weight of polyvinyl alcohol, for 100 parts by dry weight of calcium carbonate,
0.6 parts by dry weight of the optical whitener sold by the company CLARIANT™ under the name Blancophor™ P, for 100 parts by dry weight of calcium carbonate,
0.4 parts by dry weight of an acrylic thickener/water retainer sold by the company COATEX™ under the name Rheocarb™

For each of the coatings obtained from tests 1 to 3a, their Brookfield viscosities™ at 10 and 100 revolutions per minute and at 25° C. are then determined, as is its water retention. The water retention is determined using an AAGWR device sold by the company GRADEK™. It is made up of a measurement chamber in which is placed a test paper known as “Test Blotter Paper”, covered by a perforated plastic net known as “Test Filter PCTE”, the paper and the net being sold by the company GRADEK™

10 mL of the paper coating to be tested are then added into the chamber.

The AAGWR device is used to exert a certain pressure on the paper coating, causing all or some of the water and water-soluble substances contained within the coating to pass through the perforated plastic net and migrate into the test paper.

Concretely, a pressure of 0.5 bar is applied for 90 seconds.

The difference between the weight of the test paper before and after the experiment gives the weight of the water and water-soluble substances contained within the paper coating which migrated into the test paper during the experiment.

All of the results obtained for tests #1 to #3a are given in Table 1.

TABLE 1

| | Test no. | | | | | |
|---|---|---|---|---|---|---|
| | 1 | 1a | 2 | 2a | 3 | 3a |
| Prior Art (PA) | PA | IN | PA | IN | PA | IN |
| Invention (IN) | | | | | | |
| μ10 (mPa · s) | 4280 | 4360 | 2880 | 3560 | 1400 | 5660 |
| μ100 (mPa · s) | 860 | 960 | 620 | 890 | 415 | 1450 |
| PA GWR (g/m2) | 249 | 203 | 92 | 82 | 106 | 67 |

If the results are compared 2 to 2, it is observed that the Brookfield viscosities™ are always higher in the invention; this is especially remarkable for test #2a, in which the initial suspension had been much more fluid than the one corresponding to test #2.

Likewise, water retention is still much less for the invention, which means that the paper coating has migrated less into the paper substrate.

The printability of the resulting paper will therefore be improved for an equal quantity of acrylic polymer (a dispersing or grinding agent during the manufacturing of the aqueous suspension, and a thickening agent for manufacturing the paper coating), equal to that implemented in the prior art.

### Example 2

This test illustrates the implementation of the inventive polymer in an aqueous suspension of calcium carbonate, during a step of dispersion or a step of concentration. These suspensions are then used in the manufacturing of paper coatings which exhibit improved water retention and thickening, compared to a paper coating of the prior art derived from an aqueous suspension of calcium carbonate without the inventive polymer, both coatings ultimately exhibiting the same quantity of acrylic polymer (a dispersing agent or grinding aid agent added into the aqueous suspension+thickening agent added to the coating).

### Test No. 4

This test illustrates the prior art, and implements, in order to disperse a cake of calcium carbonate (Norway marble) ground without a grinding aid agent, and in which 60% by weight of the particles have a medium diameter less than 1 μm, 0.4% by dry weight in relation to the dry weight of said calcium carbonate, a copolymer of acrylic acid and maleic anhydride (in a 70/30 mass ratio):
fully neutralized by sodium hydroxide,
and with molecular weight equal to 15,600 g/mole (as determined according to the method described in the document WO 2007/069037).

An aqueous suspension is then obtained whose content of calcium carbonate by dry weight is equal to 67.4% of its total weight, and whose Brookfield™ viscosity measured at 100 revolutions per minute is less than 1,000 mPa·s, which makes it completely workable by the user.

### Test #4a

This test illustrates the prior art, and implements, in order to disperse a cake of calcium carbonate (Norway marble) in water, 0.4% by dry weight in relation to said carbonate, of a water-soluble polymer made up:
a) 75% acrylic acid by weight,
b) 25% by weight of the monomer whose formula is (I) in which.
   R represents a methacrylate radical,
   R′ represents a branched hydrophobic chain with 16 2-hexyl 1-decanyl carbon atoms,
   m=p=0, q=1, n=25.

An aqueous suspension is then obtained comparable to that obtained for test #4, because its content of calcium carbonate by dry weight is equal to 67.0% of its total weight, and whose Brookfield™ viscosity measured at 100 revolutions per minute is less than 1,000 mPa·s, which makes it completely workable by the user.

### Test No. 5

This test illustrates the prior art, and implements during a step of concentration an aqueous suspension of calcium carbonate (Finland marble) with an initial solids content of 20%, 0.8% by dry weight in relation to said carbonate, of a copolymer of acrylic acid and maleic anhydride (in a 70/30 mass ratio):
fully neutralized by sodium hydroxide,
and with molecular weight equal to 15,600 g/mole (as determined according to the method described in the document WO 2007/069037).

An aqueous suspension is then obtained whose content of calcium carbonate by dry weight is equal to 71.5% of its total weight, and whose Brookfield™ viscosity measured at 100 revolutions per minute is less than 1,000 mPa·s, which makes it completely workable by the user.

### Test #5a

This test illustrates the invention, and implements during a step of concentration an aqueous suspension of calcium carbonate (Finland marble) with an initial solids content of 20%, 0.8% by dry weight in relation to said carbonate, of a water-soluble polymer fully neutralized by sodium hydroxide and made up of:
a) 75% acrylic acid by weight,
b) 25% by weight of the monomer whose formula is (I) in which.
   R represents a methacrylate radical,
   R′ represents a branched hydrophobic chain with 16 2-hexyl 1-decanyl carbon atoms,
   m=p=0, q=1, n=25.

An aqueous suspension is then obtained comparable to that obtained for test #2, with regard to its content of calcium carbonate by dry weight, which is equal to 71.4% of its total weight. However, its Brookfield™ viscosity measured at 100 revolutions per minute is less than 1,000 mPa·s, which makes it completely workable by the user, unlike the suspension obtained for test #2.

For tests #5 and #5a, the concentration is produced according to the method well known to the person skilled in the art, by means of a thermal concentrator sold by the company EPCOM™.

For each of the tests #4 to #5a, a paper coating is then produced, made up of:
70 parts by dry weight of the aqueous suspension of calcium carbonate to be tested,
30 parts by dry weight of a powdered kaolin sold by the company HUBER™ under the name Hydragloss™ 90,
11 parts by dry weight of the styrene-butadiene latex sold by the company DOW™ CHEMICALS under the name DL 966, for 100 parts by dry weight of calcium carbonate,
1 part by dry weight of polyvinyl alcohol, for 100 parts by dry weight of calcium carbonate,
1 parts by dry weight of the optical whitener sold by the company CLARIANT™ under the name Blancophor™ P, for 100 parts by dry weight of calcium carbonate,
0.8 parts by dry weight of an acrylic thickener/water retainer sold by the company COATEX™ under the name Rheocarb™.

For each of the coatings obtained from tests 4 to 5a, their Brookfield viscosities™ at 10 and 100 revolutions per minute and at 25° C. are then determined, as is their water retention.

All of the results obtained are given in table 2.

TABLE 2

Test no.

| | 4 | 4a | 5 | 5a |
|---|---|---|---|---|
| Prior Art (PA) | PA | IN | PA | IN |
| Invention (IN) | | | | |
| μ10 (mPa · s) | 1880 | 3000 | 1280 | 3480 |
| μ100 (mPa · s) | 455 | 660 | 320 | 830 |
| PA GWR (g/m2) | 130 | 118 | 199 | 123 |

If the results are compared 2 to 2, it is observed that the Brookfield viscosities™ are always greater and that water retention is always much less in the invention; this means that the paper coating has migrated less into the paper substrate.

The printability of the resulting paper will therefore be improved for an equal quantity of acrylic polymer (a dispersing or grinding agent during the manufacturing of the aqueous suspension, and a thickening agent for manufacturing the paper coating), equal to that implemented in the prior art.

### Example 3

This test illustrates the implementation of the inventive polymer in an aqueous suspension of calcium carbonate, during a step of grinding. These suspensions are then used in the manufacturing of paper coatings which exhibit improved water retention and thickening, compared to a paper coating of the prior art derived from an aqueous suspension of calcium carbonate without the inventive polymer, both coatings ultimately exhibiting the same quantity of acrylic polymer (a dispersing agent or grinding aid agent added into the aqueous suspension+thickening agent added to the coating).

### Test No. 6

This test illustrates the prior art, and implements, in view of grinding a calcium carbonate in water (French chalk) whose diameter such that 50% by weight of the particles have a diameter greater than that value is equal to 2.4 μm, 0.45% by dry weight in relation to the dry weight of said carbonate, of a homopolymer of acrylic acid:
in which 70% by molar weight of the carboxylic sites are neutralized by sodium hydroxide and 30% by molar weight of the carboxylic sites are neutralized by lime.
and with molecular weight equal to 5,500 g/mole (as determined according to the method described in the document WO 2007/069037).

An aqueous suspension is then obtained whose content of calcium carbonate by dry weight is equal to 73.9% of its total weight, in which 39.6% and 76.7% by weight of the particles are less than 1 μm and 2 μm respectively, and whose Brookfield™ viscosity measured at 100 revolutions per minute is less than 1,000 mPa·s, which makes it completely workable by the user.

### Test #6a

This test illustrates the invention, and implements, in view of grinding a calcium carbonate in water (French chalk) whose diameter such that 50% by weight of the particles have a diameter greater than that value is equal to 2.4 μm, 0.45% by dry weight in relation to the dry weight of said carbonate, of a water-soluble polymer made up of:
a) 75% acrylic acid by weight,
b) 25% by weight of the monomer whose formula is (I) in which.
   R represents a methacrylate radical,
   R′ represents a branched hydrophobic chain with 16 2-hexyl 1-decanyl carbon atoms,
   m=p=0, q=1, n=25.

An aqueous suspension is then obtained comparable to that obtained for test #6, whose content of calcium carbonate by dry weight is equal to 73.5% of its total weight, in which 37.8% and 75.8% by weight of the particles are less than 1 μm and 2 μm respectively, and whose Brookfield™ viscosity measured at 100 revolutions per minute is less than 1,000 mPa·s, which makes it completely workable by the user.

For each of the tests #6 to #6a, a paper coating is then produced, made up of:
100 parts by dry weight of the aqueous suspension of calcium carbonate to be tested,
8 parts by dry weight of the styrene-butadiene latex sold by the company DOW™ CHEMICALS under the name DL 966, for 100 parts by dry weight of calcium carbonate,
4 parts by dry weight of starch sold by the company ROQUETTE™ under the name Amilys™,
1.5 parts by dry weight of the optical whitener sold by the company CLARIANT™ under the name Blancophor™ P, for 100 parts by dry weight of calcium carbonate,
0.3 parts by dry weight of an acrylic thickener/water retainer sold by the company COATEX™ under the name Rheocarb™.

For each of the coatings obtained from tests #6 to 6a, their Brookfield viscosities™ at 10 and 100 revolutions per minute and at 25° C. are then determined, as is their water retention.

The results obtained appear in table 3.

TABLE 3

Test no.

| | 6 | 6a |
|---|---|---|
| Prior Art (PA) | PA | IN |
| Invention (IN) | | |
| μ10 (mPa · s) | 1760 | 5440 |
| μ100 (mPa · s) | 380 | 1000 |
| PA GWR (g/m2) | 136 | 86 |

If the results are compared, it is observed that the Brookfield viscosities™ are always greater and that water retention is always much less in the invention; this means that the paper coating has migrated less into the paper substrate.

The printability of the resulting paper will therefore be improved for an equal quantity of acrylic polymer (a dispersing or grinding agent during the manufacturing of the aqueous suspension, and a thickening agent for manufacturing the paper coating), equal to that implemented in the prior art.

### Example 4

This test illustrates the implementation of the inventive polymer in an aqueous suspension of calcium carbonate, during a step of grinding. This suspension is then used in manufacturing a paper coating which exhibits improved water retention and thickening, compared to a paper coating of the prior art derived from an aqueous suspension of calcium carbonate without the inventive polymer, both coatings ultimately exhibiting the same quantity of acrylic polymer (a dispersing agent or grinding aid agent added into the aqueous suspension+thickening agent added to the coating).

### Test No. 7

This test illustrates the prior art, and implements, during a step of grinding a calcium carbonate (French calcite) whose diameter is such that 50% of the particles by weight have a diameter greater than that value, is equal to 6.7 μm, 1% by dry weight compared to the dry weight of said carbonate of a homopolymer of acrylic acid:
in which 70% by molar weight of the carboxylic sites are neutralized by sodium hydroxide and 30% by molar weight of the carboxylic sites are neutralized by lime.
and with molecular weight equal to 5,500 g/mole (as determined according to the method described in the document WO 2007/069037).

### Test No. 8

This test illustrates the invention, and implements, during a step of grinding a calcium carbonate (French calcite) whose diameter is such that 50% of the particles by weight have a diameter greater than that value, is equal to 6.7 μm, 1% by dry weight compared to the dry weight of said carbonate of a homopolymer of acrylic acid fully neutralized by sodium hydroxide and made up of:
a) 85% acrylic acid by weight,
b) 15% by weight of the monomer whose formula is (I) in which.
   R represents a methacrylate radical,
   R′ represents a branched hydrophobic chain with 16 2-hexyl 1-decanyl carbon atoms,
   m=p=0, q=1, n=25.
   Test No. 9

This test illustrates the invention, and implements, during a step of grinding a calcium carbonate (French calcite) whose diameter is such that 50% of the particles by weight have a diameter greater than that value, is equal to 6.7 μm, 1% by dry weight compared to the dry weight of said carbonate of a homopolymer of acrylic acid fully neutralized by sodium hydroxide and made up of:
a) 85% acrylic acid by weight,
b) 15% by weight of the monomer whose formula is (I) in which.
   R represents a methacrylate radical,
   R′ represents a branched hydrophobic chain with 20 2-hexyl 1-decanyl carbon atoms,
   m=p=0, q=1, n=25.

For each of the tests #7 to #9, a paper coating is then produced, made up of:
100 parts by dry weight of the aqueous suspension of calcium carbonate to be tested
11 parts by dry weight of the styrene-butadiene latex sold by the company DOW™ CHEMICALS under the name DL 966, for 100 parts by dry weight of calcium carbonate,
0.25 parts by dry weight of polyvinyl alcohol, for 100 parts by dry weight of calcium carbonate,
0.6 parts by dry weight of the optical whitener sold by the company CLARIANT™ under the name Blancophor™ P, for 100 parts by dry weight of calcium carbonate,
0.2 parts by dry weight of an acrylic thickener/water retainer sold by the company COATEX™ under the name Rheocarb™.

For each of the coatings obtained from tests 7 to 9, their Brookfield viscosities™ at 10 and 100 revolutions per minute and at 25° C. are then determined, as is their water retention, using the previously described methods. The corresponding results appear in table 4.

If the results are compared, it is observed that the Brookfield viscosities™ are always greater and that water retention is always much less in the invention; this means that the paper coating has migrated less into the paper substrate.

The printability of the resulting paper will therefore be improved for an equal quantity of acrylic polymer (a dispersing or grinding agent during the manufacturing of the aqueous suspension, and a thickening agent for manufacturing the paper coating), equal to that implemented in the prior art.

TABLE 4

| | Test no. | | |
|---|---|---|---|
| | 7 | 8 | 9 |
| Prior Art (PA) | PA | IN | IN |
| Invention (IN) | | | |
| μ10 (mPa · s) | 4640 | 17000 | 19200 |
| μ100 (mPa · s) | 850 | 2970 | 2550 |
| PA GWR (g/m2) | 95 | 64 | 60 |

1. A paper coating comprising a mineral material and a water-soluble polymer comprising:
a) at least one ethylenically-unsaturated anionic monomer,
b) and at least one ethylenically-unsaturated oxyalkylated monomer terminated by a branched hydrophobic alkyl, alkylaryl, arylalkyl, or aryl chain, whether saturated or not, having 14 to 21, and preferentially 15 to 20 carbon atoms and possessing 2 branches having at least 6 carbon atoms.

2. The paper coating according to claim 1, wherein the water-soluble polymer comprises, expressed as a percentage by the weight of each of the monomers (the total of these percentages being equal to 100%):
a) 5% to 95%, of at least one ethylenically-unsaturated anionic monomer,
b) 5% to 95%, of at least one ethylenically-unsaturated oxyalkylated monomer terminated by a branched hydrophobic alkyl, alkylaryl, arylalkyl, or aryl chain, whether saturated or not, having 14 to 21, possessing 2 branches having at least 6 carbon atoms.

3. The paper coating according to claim 1, wherein the monomer a) is acrylic acid, or methacrylic acid, or mixtures thereof.

4. The paper coating according to claim 1, wherein the monomer b) is a monomer whose formula is (I): 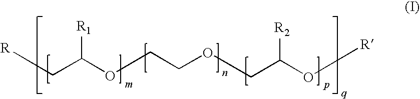
where:
m, n, p and q are whole numbers and m, n, p are less than 150, q is greater than 0, and at least one whole numbers among m, n and p is nonzero;
R is a radical comprising a polymerizable unsaturated function, belonging to the group of vinylics as well as the group of acrylic, methacrylic, and maleic esters, and to the group of unsaturated urethanes such as acrylurethane, methacrylurethane, α-α′ dimethyl-isopropenyl-benzylurethane, allylurethane, as well as to the group of allylic or vinylic ethers, whether substituted or not, or to the group of ethylenically unsaturated amides or imides,
R₁ and R₂ are identical or different, and represent hydrogen atoms or alkyl groups,
R′ represents a branched hydrophobic alkyl, alkylaryl, arylalkyl, or aryl chain, whether saturated or not, having 14 to 21, preferentially 15 to 20 carbon atoms.

5. The paper coating according to claim 1, wherein the water-soluble polymer is partially or fully neutralized by one or more neutralization agents having a monovalent or polyvalent function.

6. The paper coating according to claim 1, wherein the coating comprises at least one mineral material which is selected from the group consisting of natural or synthetic calcium carbonate, kaolin, talc, and mixtures thereof.

7. The paper coating according to claim 1, wherein the percentage by dry weight of said polymer in relation to the dry weight of mineral material is between 0.1% and 2%.

8. The paper coating according to claim 4, wherein R′ is 2-hexyl 1-decanyl, 2-octyl 1-dodecanyl or mixtures thereof.

9. The paper coating according to claim 5, wherein the one or more neutralization agents is sodium hydroxide, potassium hydroxide, or mixtures thereof.

10. The paper coating according to claim 6, wherein the mineral material is a mixture of natural calcium carbonate and kaolin.

11. A method of manufacturing a paper coating, comprising adding a mineral material to a water-soluble polymer comprising:
a) at least one ethylenically-unsaturated anionic monomer,
b) and at least one ethylenically-unsaturated oxyalkylated monomer terminated by a branched hydrophobic alkyl, alkylaryl, arylalkyl, or aryl chain, whether saturated or not, having 14 to 21, and preferentially 15 to 20 carbon atoms and possessing 2 branches having at least 6 carbon atoms.

12. The paper coating according to claim 11, wherein the water-soluble polymer comprises, expressed as a percentage by the weight of each of the monomers (the total of these percentages being equal to 100%):
a) 5% to 95% of at least one ethylenically-unsaturated anionic monomer,
b) 5% to 95% of at least one ethylenically-unsaturated oxyalkylated monomer terminated by a branched hydrophobic alkyl, alkylaryl, arylalkyl, or aryl chain, whether saturated or not, having 14 to 21, and possessing 2 branches having at least 6 carbon atoms.

13. The paper coating according to claim 11, wherein the monomer a) is acrylic acid, or methacrylic acid, or mixtures thereof.

14. The paper coating according to claim 11, wherein the monomer b) is a monomer whose formula is (I): 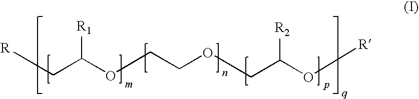
where:
m, n, p and q are whole numbers and m, n, p are less than 150, q is greater than 0, and at least one whole numbers among m, n and p is nonzero;
R is a radical comprising a polymerizable unsaturated function, belonging to the group of vinylics as well as the group of acrylic, methacrylic, and maleic esters, and to the group of unsaturated urethanes such as acrylurethane, methacrylurethane, α-α′ dimethyl-isopropenyl-benzylurethane, allylurethane, as well as to the group of allylic or vinylic ethers, whether substituted or not, or to the group of ethylenically unsaturated amides or imides,
R₁ and R₂ are identical or different, and represent hydrogen atoms or alkyl groups,
R′ represents a branched hydrophobic alkyl, alkylaryl, arylalkyl, or aryl chain, whether saturated or not, having 14 to 21, preferentially 15 to 20 carbon atoms, and possessing 2 branches having at least 6 carbon atoms.

15. The paper coating according to claim 11, wherein the water-soluble polymer is partially or fully neutralized by one or more neutralization agents having a monovalent or polyvalent function.

16. The paper coating according to claim 11, wherein the coating comprises at least one mineral material which is selected from the group consisting of natural or synthetic calcium carbonate, kaolin, talc, and mixtures thereof.

17. The paper coating according to claim 11, wherein the percentage by dry weight of said polymer in relation to the dry weight of mineral material is between 0.1% and 2%.

18. The paper coating according to claim 14, wherein R′ is 2-hexyl 1-decanyl, 2-octyl 1-dodecanyl or mixtures thereof.

9. The paper coating according to claim 15, wherein the one or more neutralization agents is sodium hydroxide, potassium hydroxide, or mixtures thereof.

20. A method of coating paper comprising applying the paper coating according to claim 1 to a paper substrate.
